(19) United States
(12) Patent Application Publication
(10) Pub. No.: US 2017/0248715 A1
(43) Pub. Date: Aug. 31, 2017

(54) SIMULTANEOUS MULTI-VINTAGE TIME-LAPSE FULL WAVEFORM INVERSION

(71) Applicant: CGG SERVICES SAS, Massy Cedex (FR)

(72) Inventors: Tim SEHER, Bromley (GB); Henning HOEBER, East Grinstead (GB); Andrew RATCLIFFE, Henfield (GB)

(73) Assignee: CGG SERVICES SAS, Massy Cedex (FR)

(21) Appl. No.: 15/511,606

(22) PCT Filed: Sep. 22, 2015
(86) PCT No.: PCT/IB2015/001969

§ 371 Date: Mar. 15, 2017

Related U.S. Application Data
(60) Provisional application No. 62/053,244, filed on Sep. 22, 2014.

(51) Int. Cl. G01V 1/28; G01V 1/30

(52) U.S. Cl. CPC G01V 1/282; G01V 1/308; G01V 1/303; G01V 2210/612

(57) ABSTRACT

Simultaneous inversion of multi-vintage seismic data obtains seismic data for vintages and generates an initial earth model for each vintage. A cost function includes a data norm term having for at least one pair of vintages of seismic data a difference norm between a difference in obtained seismic data for the at least one pair of vintages and a difference in modeled seismic data for the at least one pair of vintages. The cost function also includes a model norm term for each pair of vintages selected from at least three vintages of seismic data. Each model norm term includes a difference norm between earth models for a given pair of vintages. A closure relationship is imposed on all earth models. The earth models are adjusted for the vintages to drive the cost function to a minimum and to produce updated earth models.

### CROSS REFERENCE TO RELATED APPLICATIONS

This application claims priority and benefit from U.S. Provisional Patent Application No. 62/053,244, filed Sep. 22, 2014, for “Simultaneous Multi-Vintage Time-lapse Full Waveform Inversion”, the entire contents of which is incorporated herein by reference.

### TECHNICAL FIELD

Embodiments of the subject matter disclosed herein generally relate to methods and systems for seismic data processing and imaging and, more particularly, to mechanisms and techniques for time lapse or 4D (4-dimension) seismic processing, imaging and inversion.

### BACKGROUND

Seismic data acquisition and processing techniques are used to generate a profile (image) of a geological structure (subsurface) of the strata underlying the land surface or seafloor. Among other things, seismic data acquisition involves the generation of seismic waves, the collection of reflected/refracted versions of those waves, and the processing of the collected seismic data to generate the image.

A configuration for achieving land seismic data is illustrated in FIG. 1. FIG. 1 shows a system 100 that includes multiple receivers 102 that are positioned over a monitored area 104 of a subsurface to be explored and that are in contact with, or below the surface 106 of, the ground. A number of dedicated seismic sources 108 are also placed on the surface 106 in an area 110, for example an adjacent area, to the monitored area 104 containing the receivers 102. A dedicated seismic source is defined as a device built by man with the main purpose of generating seismic waves to be used for a seismic survey. As an alternative to being placed on the surface, dedicated seismic sources 108 are buried under surface 106. A central recording device 112 is connected to the plurality of receivers 102 and placed, for example, in a station or truck 114. Each dedicated seismic source 108 can be composed of a variable number of vibrators, typically between one and five, and can include a local controller 116. A central controller 118 can be provided to coordinate the shooting times of sources 108. A global positioning system (GPS) 120 can be used to time-correlate shooting of the dedicated seismic sources 108 and the recordings of the receivers 102.

With this configuration, dedicated seismic sources 108 are controlled to intentionally generate seismic waves, and the plurality of receivers 102 records waves reflected by oil and/or gas reservoirs and other structures and reflection points, e.g., the interface between subsurface formations having different impedances. The result of the seismic survey contains seismic data for geophysical parameters of subterranean rock formations. The seismic survey records both compressional, or P-waves and shear, or S-waves and is a combination of source wavelet and earth properties.

Analysis of the seismic data interprets earth properties and removes or minimizes the effects of the source wavelet. One type of analysis uses the three dimensional (3D) seismic data to obtain the geophysical properties of the subsurface layer such as P-wave velocity Vₚ, S-wave velocity Vₛ and density ρ, which can be used to determine other properties of interest such as impedance, porosity, lithology, fluid saturation as well as other geomechanical properties. This analysis is known as 3D inversion. These properties are used to provide the location and structure of subsurface oil and gas reservoirs in addition to the structure of the overburden and the subsurface area surrounding the oil and gas reservoirs. For example, removal of the oil and gas from the reservoirs and introduction, for example, of water into the reservoirs to aid in the removal of the oil change the geomechanical properties of the reservoir and the location of the oil and gas within the reservoir. Therefore, seismic surveys are taken at different times in order to monitor these changes. Comparison of seismic surveys taken at different times, i.e., vintages, yields data on the changes in the properties of the subsurface layers. The changes in seismic data can be in amplitude or phase or both and both can be frequency dependent. For the purposes of using inversion to obtain the changes in properties between vintages, time, i.e., calendar time, is viewed as a fourth dimension, and the process is called 4D inversion.

The initial seismic survey is the base survey and any subsequent seismic survey is a monitor seismic survey. Independent inversion of base and monitor seismic surveys can yield estimates of elastic properties that are inconsistent with expected production effects, for example due to noise or to the non-uniqueness of the inversion method. Approaches to conducting 4D seismic inversion include inverting base and monitor surveys separately and then differencing the results to calculate changes in elastic attributes; using inversion results for a base survey to define an initial model for inverting a monitor survey; inverting all differences, time, phase and amplitude, directly for changes in elastic parameters and inverting all vintages simultaneously. This last approach where all vintages are inverted simultaneously is referred to as simultaneous inversion. Simultaneous inversion of base and monitor is used to obtain more reliable quantitative estimates of impedance changes and to reduce the non-uniqueness of the inversion process.

The need still exists, however, for improved time-lapse (4D) processing that more accurately estimates seismic velocities and velocity variations from multiple seismic vintages.

### SUMMARY OF THE INVENTION

Exemplary embodiments are directed to systems and methods that provide an improved time-lapse full waveform inversion (FWI). In one embodiment, three or more vintages of seismic data are inverted simultaneously using a cost function that links the velocity models of the various vintages through a closure relation. This ensures that the estimated velocity changes are consistent between vintages. In another embodiment, two or more vintages of seismic data are inverted using a cost function based on the data and data differences. This allows leveraging knowledge from time-lapse processing. Suitable inversion processes include, but are not limited to, FWI.

Simultaneous inversion of two or more seismic data vintages, or alternatively three or more seismic data vintages, provides numerous advantages. First, adding additional data reduces the model parameter uncertainty by exploiting redundancy between different datasets. Second, inverting simultaneously for multiple datasets removes the effect of the baseline velocity model inherent to previous inversion techniques. Third, simultaneous FWI of multiple datasets delivers estimates of both velocity and velocity change from a single framework.

In addition to those benefits, using data differences and amplitude data at the same time provides two distinct advantages. First, the scaling problem related to time-lapse induced amplitude changes is addressed. While the amplitude values are large, the time-lapse amplitude changes are comparatively small. Separating the two effects allows weighting the different sources of information. Second, separating the amplitudes and amplitude changes allows exploiting concepts of 4D seismic imaging, e.g., binning, survey matching, and stabilized data subtraction. For example, only closely collocated, high quality seismic measurements can be used for estimating time-lapse amplitude changes. Similarly, different techniques exist to mitigate the noise amplification inherent to time-lapse data subtraction, e.g., regularized data subtraction.

One exemplary embodiment is directed to a method for inversion of multi-vintage seismic data in which seismic data of a subsurface structure are obtained for a plurality of vintages. An initial earth model of the subsurface structure is generated for each one of the plurality of vintages, and a cost function is defined that includes a data norm term containing for at least one pair of vintages of seismic data, a difference norm between a difference in obtained seismic data for the at least one pair of vintages and a difference in modeled seismic data for the at least one pair of vintages. The earth models for the at least one pair of vintages are adjusted to drive the cost function to a minimum and to produce updated earth models for the subsurface structure for the at least one pair of vintages. In one embodiment, the modeled seismic data for a given vintage is a function of the earth model for that given vintage.

In one embodiment, one vintage in the at least one pair of vintages is a baseline vintage, and the cost function is defined to include the data norm term containing a difference norm between obtained seismic data for the baseline vintage and modeled seismic data for the baseline vintage. In one embodiment, defining the cost function further includes defining the cost function containing the data norm term that includes for each pair of vintages selected from at least three vintages of seismic data a difference norm between the difference in obtained seismic data for a given pair of vintages and the difference in modeled seismic data for the given pair of vintages. The earth models for the at least three vintages are adjusted to drive the cost function to a minimum and to produce updated earth models for the subsurface structure for the at least three vintages.

In one embodiment, the cost function includes a model norm term containing for each pair of vintages selected from at least three vintages of seismic data a difference norm between earth models for a given pair of vintages. In one embodiment, the cost function includes the model norm term containing a Lagrange multiplier for each difference norm between earth models for the given pair of vintages. In one embodiment, the cost function includes the model norm term that contains the difference norm between earth models for the given pair of vintages wherein each difference in the difference norm is acted upon by an operator. In one embodiment, a closure relationship is imposed on all earth models from the at least three vintages in the plurality of vintages. The closure relationship defines consistent differences between all possible combinations of differences between earth models of subsequent vintages.

Exemplary embodiments are also directed to a method for inversion of multi-vintage seismic data. In this method seismic data of a subsurface structure are obtained for a plurality of vintages. An initial earth model of the subsurface structure is generated for each one of the plurality of vintages. A cost function is defined that includes a model norm term for each pair of vintages selected from at least three vintages of seismic data. Each model norm term includes a difference norm between earth models for a given pair of vintages. The earth models for the at least three vintages are adjusted to drive the cost function to a minimum and to produce updated earth models for the subsurface structure for the at least three vintages.

In one embodiment, the cost function is defined to include the model norm term containing a Lagrange multiplier for each difference norm between earth models for the given pair of vintages. In one embodiment, the cost function is defined to include the model norm term containing the difference norm between earth models for the given pair of vintages wherein each difference in the difference norm is acted upon by an operator. In one embodiment, a closure relationship is imposed on all earth models from the at least three vintages in the plurality of vintages. The closure relationship defines consistent differences between all possible combinations between earth models of subsequent vintages.

In one embodiment, the cost function includes a data norm term. In addition, one vintage in the at least three vintages is a baseline vintage, and the cost function is defined to include the data norm term having a difference norm between obtained seismic data for the baseline vintage and modeled seismic data for the baseline vintage.

Exemplary embodiments are also directed to a computing system for inversion of multi-vintage seismic data. The computing system includes a communication module that is used to obtain seismic data of a subsurface structure for a plurality of vintages. Also included is a processer, e.g., a central processing unit, in communication with the communication module. The processor is configured to generate an initial earth model of the subsurface structure for each one of the plurality of vintages, define a cost function containing a data norm term that includes for at least one pair of vintages of seismic data a difference norm between a difference in obtained seismic for the at least one pair of vintages and a difference in modeled seismic data for the at least one pair of vintages and to adjust the earth models for the at least one pair of vintages to drive the cost function to a minimum and to produce updated earth models for the subsurface structure for the at least one pair of vintages.

In one embodiment, one vintage in the at least one pair of vintages is a baseline vintage, and the processor is further configured to define the cost function having the data norm term that includes a difference norm between obtained seismic data for the baseline vintage and modeled seismic data for the baseline vintage. In one embodiment, the processor is further configured to define the cost function containing a model norm term that includes for each pair of vintages selected from at least three vintages of seismic data a difference norm between earth models for a given pair of vintages, and to impose a closure relationship on all earth models from the at least three vintages in the plurality of vintages. The closure relationship defines consistent differences between all possible combinations of differences between earth models of subsequent vintages.

In one embodiment, that processor is further configured to define the cost function having the model norm term that includes a Lagrange multiplier for each difference norm between earth models for the given pair of vintages. In another embodiment, the processor is further configured to define the cost function having the model norm term that includes the difference norm between velocity models for the given pair of vintages wherein each difference in the difference norm is acted upon by an operator.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a conventional land seismic data acquisition system;

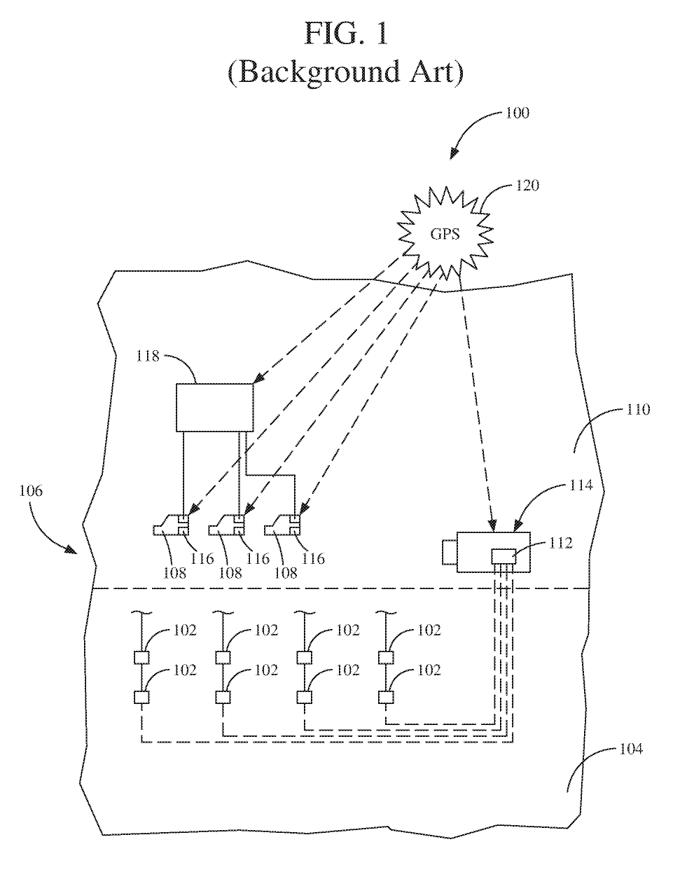

FIG. 2 is a flowchart of an embodiment of a method for inversion of multi-vintage seismic data;

FIG. 3 is a flowchart of another embodiment of a method for inversion of multi-vintage seismic data; and

FIG. 4 is a schematic representation of an embodiment of a computing system for use in executing a method for inversion of multi-vintage seismic data.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to local activity taking place within the area of a seismic survey. However, the embodiments to be discussed next are not limited to this configuration, but may be extended to other arrangements that include regional activity, conventional seismic surveys, etc.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Exemplary embodiments of systems and methods obtain real seismic data for a given geophysical subsurface structure at a plurality of distinct survey times or vintages. The subsurface structure contains features, for example, one or more reservoirs and related surrounding area, for which current geophysical data are desired or for which changes in the geophysical data (both in terms of frequency amplitude and phase differences) resulting from reservoir productions is desired. Any suitable method for obtaining seismic data from a subsurface structure can be used. Suitable spacing between the vintages includes, but is not limited to, hours, days, weeks, months, years and combinations thereof.

The plurality of distinct survey times or vintages includes a first, base or initial survey time vintage and at least one second, subsequent or monitor survey time vintage. The seismic data can include any number of vintages, for example two vintages, four vintages or more vintages. In one embodiment, the distinct survey times include a base survey time and a plurality of subsequent monitor survey times.

Exemplary embodiments utilize a time-lapse (4D) full waveform inversion (FWI) for all vintages in order to obtain the basic geophysical properties, e.g., Vₚ, Vₛ and ρ for the subsurface structure covered by the seismic data. From these properties, additional properties of the subsurface structure that are of interest in describing the current state of the subsurface structure, e.g., P-impedance Iₚ and S-impedance Iₛ, or changes to the subsurface structure containing a reservoir are calculated. The number of vintages that are utilized in the 4D FWI is not restricted.

In addition to the seismic data contained in the plurality of vintages, inputs into the inversion can include wavelets, initial models of the subsurface structure, constraints between vintages that are derived, for example, from the known rock physics of the subsurface structure and expected changes to the subsurface structure resulting from oil production from the reservoir in the subsurface structure, and a time-shift map to account for differences for a given two way time, twt, between vintages as provided from the input model and the inversion estimation. In general, inversion utilizes a gradient-based, often steepest descent-like, algorithm in which a cost function is defined and is used to process proposed changes or perturbations in the geophysical properties, e.g., Vₚ, Vₛ, ρ and twt, in order to obtain a local optimal solution for the desired subsurface properties.

The 4D FWI utilizes the inputs and any constraints and begins the inversion process from the initial model. Given the initial model, a perturbation of properties for each vintage, e.g., Vₚ, Vₛ, ρ and twt, is iteratively obtained that optimizes the defined cost function that includes terms for two, three or more vintages of seismic data. Optimizing this multi-vintage cost function that includes multiple terms provides for the simultaneous inversion of multi-vintage seismic data. These multiple terms in the cost function include, but are not limited to, a model norm term and a data norm term. Other suitable terms include a lateral continuity term that provides multi-trace lateral continuity constraints and controls the smoothness of the results and a prior model term that controls the distance the solution is allowed to move away from the initial model.

Time-lapse Full Waveform Inversion (4D FWI) in accordance with exemplary embodiments estimates seismic velocities and velocity variations from multiple seismic vintages. Other earth model parameters can also be inverted in a FWI sense. These additional earth model parameters include, but are not limited to, P-impedance Iₚ and S-impedance Iₛ, density, thickness and anisotropy. These multiple seismic vintages are derived from seismic experiments carried out at different points in time and in combination form a time-lapse seismic dataset. This time-lapse seismic dataset contains two, three or more separate seismic vintages, for example, one baseline survey vintage and at least one monitor survey vintage. These vintages in the time-lapse seismic dataset are the input for 4D FWI. The inversion process or algorithm optimizes, i.e., minimizes or maximizes, the defined cost function through an iterative process. The cost function is defined to express a misfit or difference between observed seismic data and calculated, predicted or modeled seismic data for each vintage. Other forms of the cost function can be used, for example, a cost function that is a function of a matching filter containing a mapping between the observed seismic data and the modeled seismic data such that the matching filter is optimized directly, which indirectly optimizes the data difference. Each iteration changes parameters in the modeled seismic data, e.g., geophysical properties of the subsurface, until the expressed difference and the associated cost function are optimized.

In one embodiment, the cost function includes a data norm term for two or more seismic data vintages. In this embodiment, the data norm term includes a difference norm between the difference in the real data and the difference in the model data for each pair of vintages in the two or more seismic data vintages. Any suitable type of difference norm known and available in the art can be used. In addition, the data norm term can include the difference norm between the real data and the modeled data for the two or more seismic data vintages.

In another embodiment, the cost function includes a data norm term and a model norm term for three or more seismic data vintages. Suitable data norm terms include conventional data norm terms and the data norm term disclosed above that includes a difference norm between the difference in the real data and the difference in the model data for each pair of vintages in the three or more seismic data vintages. The model norm term includes a difference norm between velocity models for each pair of seismic vintages in the three or more seismic vintages. Again, any type of difference norm can be used. In addition, all of the velocity models associated with the seismic vintages are subject to a closure relationship. Other suitable terms for the cost function include a misfit term between the modeled data and the real data, a lateral continuity term that measures and controls the lateral continuity of the estimated parameters, a prior model term that measures and controls the distance between the prior and current models.

Exemplary embodiments of the inversion algorithm can be understood with regard to different implementations of a general cost function C that combines two terms, a data norm C_{d} and a model norm Cₘ, for example, a velocity model norm. For the conventional cost function the data and model norm is summed, C=C_{d}+Cₘ. Similarly, the two norms are multiplied for a multiplicative cost function, C=C_{d}×Cₘ. In general, the data norm penalizes the misfit between observed and calculated seismic data, while the model norm reinforces certain properties of a model among different vintages in the multi-vintage seismic data.

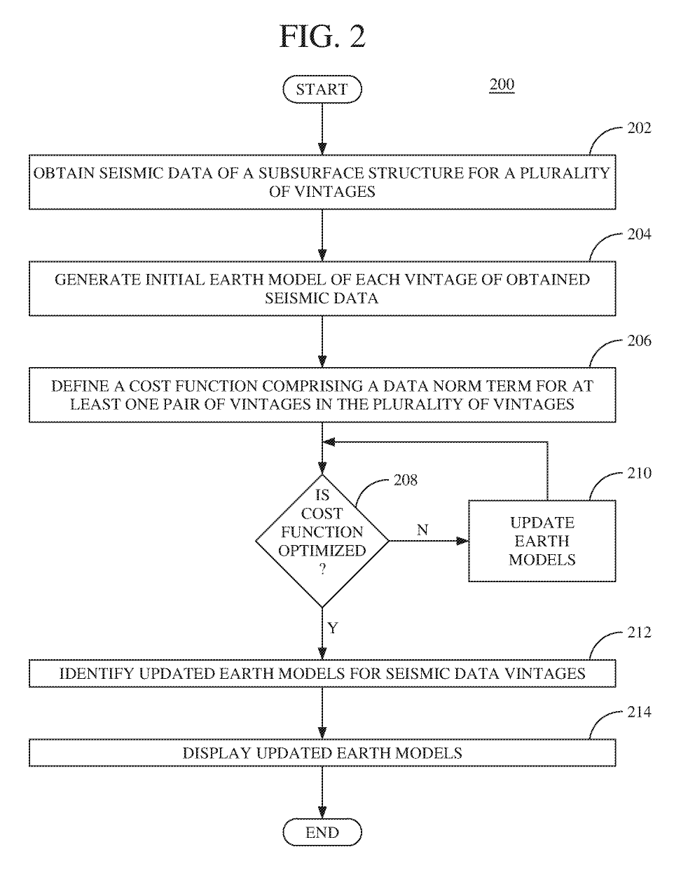

Referring to FIG. 2, one exemplary embodiment is directed to a method for inversion of multi-vintage seismic data 200. Seismic data of a subsurface structure are obtained for a plurality of vintages 202. Any suitable method for obtaining seismic data can be used, and each vintage is separated by a period of time. An initial earth model, for example, a velocity model, of the subsurface structure for each one of the plurality of vintages is generated 204. A cost function is defined that includes a data norm term for at least one pair of vintages of seismic data selected from the plurality of vintages of obtained seismic data 206. The data norm term includes a difference norm between a difference in the obtained seismic data for the at least one pair of vintages and a difference in modeled seismic data for the at least one pair of vintages. Any suitable norm known and available in the art can be used. Examples of suitable norms include, but are not limited to, the L1 norm and the L2 norm.

In one embodiment, one vintage in the at least one pair of vintages is a baseline vintage. As used herein, baseline vintage refers to one of the vintages being used as a reference or starting point. This baseline or reference vintage can by the vintage that was acquired first in calendar time or can be any other vintage selected as a reference based on other criteria. For example, the baseline vintage can be the vintage associated with the noisiest data. The cost function is defined to include in the data norm term the difference norm between obtained seismic data for the baseline vintage and modeled seismic data for the baseline vintage. In addition to having just two or a single pair of vintages accounted for in the cost function, the cost function can be defined to include the data norm term for each pair of vintages selected from at least three vintages of seismic data. The difference norm is provided between the difference in obtained seismic data for a given pair of vintages and the difference in modeled seismic data for the given pair of vintages. This difference norm term is repeated until all possible pairings for the selected group of vintages in the plurality of vintages of obtained seismic data are covered.

In general, the data norm term is defined as C_{d}=Σᵢ₌₁ⁿ|dᵢ−f(mᵢ)|²+λΣᵢ₌₁ⁿΣⱼ₌ᵢ₊₁ⁿ|(dᵢ−f(mᵢ)−(dⱼ−f(mⱼ))|². As used in the data norm term, the double brackets indicate the norm, d denotes the seismic data for a given vintage, m is the earth model for a given vintage and is a weighting operator such as the Lagrange operator. The function, f, is the forward operator that calculates synthetic data from the earth model. Therefore, the modeled seismic data for a given vintage is a function of the earth model for that given vintage. Changing the earth model for the subsurface region changes the synthetic data or model data for the subsurface region.

Considering an embodiment for three vintages of seismic data selected from the plurality of vintages of the obtained seismic data, e.g., a base vintage and two subsequent vintages, the data norm term that utilizes the baseline amplitude data and the data differences between the baseline survey and the two subsequent or monitoring surveys is defined as C_{d}=|d₀−f(m₀)|+|(d₁−d₀)−(f(m₁)−f(m₀))|+|(d₂−d₀)−(f(m₂)−f(m₀))|+|(d₂−d₁)−(f(m₂)−f(m₁))|. In this data norm term, the double brackets indicate the norm, d denotes the seismic data for a given vintage, and m is the earth model, for example, a compressional wave velocity model, for a given vintage, which can also be multiple parameters at each location. The function, f, is the forward operator that calculates synthetic data from the earth model. Therefore, the modeled seismic data for a given vintage is a function of the earth model for that given vintage. Changing the earth model for the subsurface region changes the synthetic data for the subsurface region. The illustrated three vintage expression for the data norm can be extended to include additional vintages by adding the appropriate terms for each vintage.

As illustrated, the first term in the equation for C_{d} is the difference norm between obtained seismic data for the baseline vintage and modeled seismic data for the baseline vintage, |d₀−f(m₀)|. In general, the difference norm for any vintage, i, is expressed by |dᵢ−f(mᵢ)|. However, this term does not have to be included for all of the vintages and may only be included for the baseline vintage. Each subsequent term is the data norm expressing a difference between differences for a given pairing of vintages. Therefore, each data norm includes the difference between obtained seismic data for a given pair of vintages, (dₓ−d_{y}) and the difference between modeled data for the same given pair of vintages as determined by a current, i.e., initial or updated, velocity model for those vintages, (f(mₓ)−f(m_{y})). The data norm looks at the difference between those differences, and all these differences are summed across all data norms with one data norm for each paring of vintages.

In one embodiment, the cost function can be defined to include a model norm term in addition to the data norm term. The model norm term includes, for each pair of vintages selected from at least three vintages of seismic data a difference norm between earth models for a given pair of vintages. In one embodiment, a Lagrange multiplier is associated with each difference norm. In another embodiment, an operator is applied to the difference between velocity models in each difference norm in the model norm term. All models in the model norm term are subject to a closure relationship that imposes consistent velocity changes between the models of all vintages.

Embodiments of simultaneous 4D FWI using seismic data and data differences as expressed in the data norm term of the cost function can use the data norm term alone or in combination with the model norm term. In general, all 4D FWI algorithms use the seismic amplitude data for the baseline and monitor surveys as input. Exemplary embodiments use both baseline amplitude data and the data differences between the baseline survey and different monitor surveys as input.

As discussed above, an iterative process is conducted to optimize the defined cost function. Optimization includes driving the value of the cost function to a minimum, ideally zero. Therefore, a check is made to see if the defined cost function is optimized 208, e.g., has a value of zero or has reached a minimum. If the cost function is not optimized, then the earth models for the at least one pair of vintages, or for any vintage of obtained seismic data that is covered by the cost function, is adjusted 210. These adjustments are repeated to drive the cost function to its minimum. If the cost function is optimized, then updated earth models for the subsurface structure for the at least one pair of vintages or for any vintage of obtained seismic data that is covered by the cost function, are produced or identified 212. In one embodiment, the earth models for the at least three vintages are adjusted to drive the cost function to its minimum and to produce updated models for the subsurface structure for the at least three vintages. Therefore, multiple vintages of seismic data can be inverted and optimized simultaneously. The updated earth models can then be displayed 214 or otherwise output or stored.

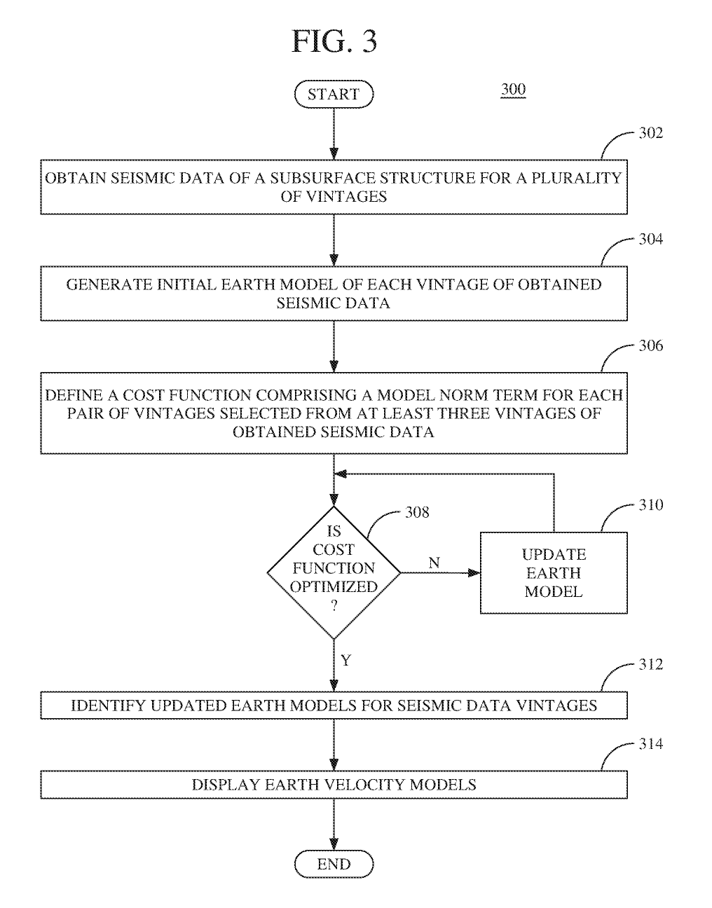

Referring to FIG. 3, one exemplary embodiment is directed to a method for inversion of multi-vintage seismic data 300. Seismic data of a subsurface structure are obtained for a plurality of vintages 302. Any suitable method for obtaining seismic data can be used, and each vintage is separated by a period of time or acquired at a different calendar time. An initial earth model, for example, a velocity model, of the subsurface structure for each one of the plurality of vintages is generated 304. A cost function is defined that includes a model norm term for each pair of vintages selected from at least three vintages of seismic data 306. The model norm terms includes a difference norm between earth models for each given pair of vintages.

Implementation of the model norm, Cₘ, in the cost function of 4D FWI assures that all earth models are similar, where no significant changes occur. In an exemplary embodiment where the time-lapse seismic dataset includes three vintages, the model norm for simultaneous inversion is defined as:

Cₘ=γ₁|L(m₁−m₀)|+γ₂|L(m₂−m₁)|+γ₃|L(m₂−m₀)|.

As used in the model norm equation, the m represents an earth model for a base line vintage, m₀, an earth model for a first vintage, m₁, and an earth model for a second vintage, m₂. In one embodiment, the cost function is defined to include a Lagrange multiplier for each difference norm between models for each given pair of vintages. As illustrated, γ is a Lagrange multiplier, and a separate one is provided for each one of the three difference norms in the model norm equation; however, other scaling mechanisms as known and available in the art can also be used. In one embodiment, the cost function includes an operator applied to each model difference in each difference norm. As illustrated, L is an operator that can be used to weight different parts of the model differences, which are vector differences. In one embodiment corresponding to a simplest implementation, L is the unity operator. The double brackets represent the difference norm, and any suitable type of difference norm known and available in the art can be used, for example, the L2 or L1 norm.

In one embodiment, a closure relationship is imposed on all earth models from the at least three vintages in the plurality of vintages. The closure relationship includes relations that drive the inversion to consistent models. For the three vintage example of the model norm illustrated above, a closure relationship is imposed on the models associated with the three vintages: (m₁−m₀)+(m₂−m₁)−(m₂−m₀)=0. In general, this closure relationship is imposed on the models associated with any model norm for more than two vintages. The closure relationship ensures that the time-lapse models are consistent. Therefore, in the three vintage embodiment illustrated above, the change measured between vintage 1 and the baseline plus the change between vintage 2 and vintage 1 equals the change measured between vintage 2 and the baseline vintage. The closure relationship is extended to any number of vintages including more than three vintages. In an embodiment a plurality of closure relationships are possible, and some of these closure relationships utilize only subsets of all available vintages. With a plurality of closure relationships, not all closure relationships are used in the cost function.

In one embodiment, the cost function further also includes a data norm term. Suitable data norm terms include conventional data norm terms and any of the data norm terms discussed above. In one embodiment, one vintage in the at least three vintages is a baseline vintage, and the cost function includes the data norm term containing a difference norm between obtained seismic data for the baseline vintage and modeled seismic data for the baseline vintage.

An iterative process is conducted to optimize the defined cost function. Optimization includes driving the value of the cost function to a minimum, ideally zero. Therefore, a check is made to see if the defined cost function is optimized 308, e.g., has a minimum or a value of zero. If the cost function is not optimized, then the models for the at least one pair of vintages, or for any vintage of obtained seismic data that is covered by the cost function, is adjusted 310. These adjustments are repeated to drive the cost function to a minimum or a value of zero. If the cost function is optimized, then the updated earth models for the subsurface structure for the at least one pair of vintages or for any vintage of obtained seismic data that is covered by the cost function, is produced or identified 312. In one embodiment, the earth models for the at least three vintages are adjusted to drive the cost function to a minimum or a value of zero and to produce updated earth models for the subsurface structure for the at least three vintages. Therefore, multiple vintages of seismic data can be inverted and optimized simultaneously. The updated earth models can then be displayed 314 or otherwise outputted or stored.

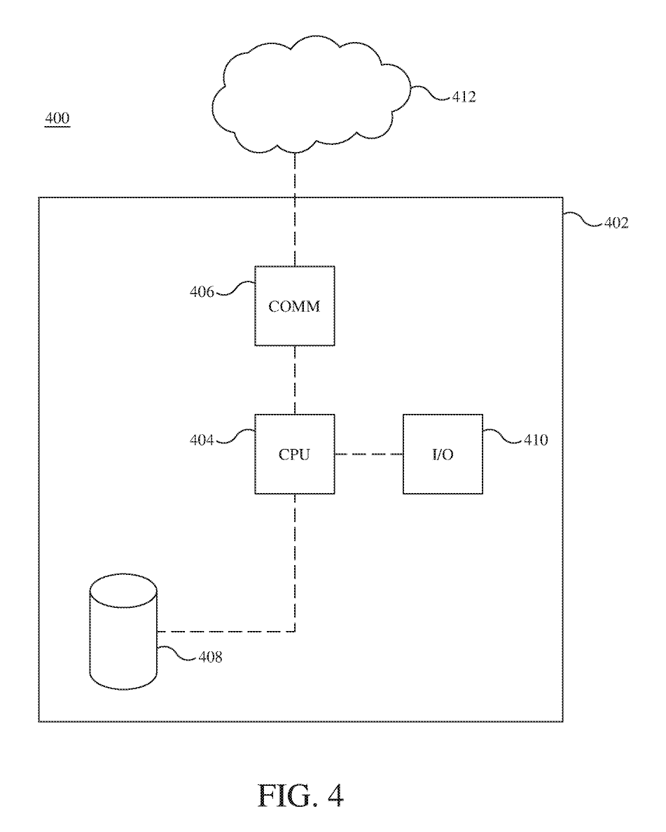

Referring to FIG. 4, exemplary embodiments are directed to a computing system 400 for inversion of multi-vintage seismic data, preferably the simultaneous inversion of multi-vintage seismic data. In one embodiment, a computing device for performing the calculations as set forth in the above-described embodiments may be any type of computing device capable of obtaining, processing and communicating multi-vintage seismic data associated with seismic surveys conducted at different time periods. The computing system 400 includes a computer or server 402 having one or more central processing units 404 in communication with a communication module 406, one or more input/output devices 410 and at least one storage device 408.

The communication module is used to obtain seismic data of a subsurface structure for a plurality of vintages. These seismic data can be obtained, for example, through the input/output devices. The obtained seismic data are stored in the storage device. In addition, the storage device is used to store initial and updated earth models as well as the computer executable code that is used to execute the methods for simultaneous inversion of multi-vintage seismic data. The input/output device can also be used to communicate or display outputs and updated earth models, for example, to a user of the computing system.

The processer is in communication with the communication module and configured to generate an initial earth model of the subsurface structure for each one of the plurality of vintages, define a cost function containing a data norm term for at least one pair of vintages of seismic data. The data norm term including a difference norm between a difference in obtained seismic for the at least one pair of vintages and a difference in modeled seismic data for the at least one pair of vintages. The processor is further configured to adjust the earth models for the at least one pair of vintages to drive the cost function to a minimum, ideally a value of zero, and to produce updated earth models for the subsurface structure for the at least one pair of vintages, which can be stored in the database, displayed in the input/output devices or communicated with the communication module.

In one embodiment, one vintage in the at least one pair of vintages is a baseline vintage and the processor defines the cost function to include the data norm term having a difference norm between obtained seismic data for the baseline vintage and modeled seismic data for the baseline vintage. In one embodiment, the processor defines the cost function to include a model norm term that includes for each pair of vintages selected from at least three vintages of seismic data a difference norm between earth models for a given pair of vintages. The processor also imposes one or more closure relationships on all earth models from the at least three vintages in the plurality of vintages. This closure relationship ensures that the changes between different data are self-consistent.

In one embodiment, the processor defines the cost function to include a Lagrange multiplier for each difference norm between velocity models for the given pair of vintages and an operator applied to the difference between velocity models for the given pair of vintages in each difference norm.

Suitable embodiments for the various components of the computing system are known to those of ordinary skill in the art, and this description includes all known and future variants of these types of devices. The communication module provides for communication with other computing systems, databases and data acquisition systems across one or more local or wide area networks 412. This includes both wired and wireless communication. Suitable input/output devices include keyboards, point and click type devices, audio devices, optical media devices and visual displays.

Suitable storage devices include magnetic media such as a hard disk drive (HDD), solid state memory devices including flash drives, ROM and RAM and optical media. The storage device can contain data as well as software code for executing the functions of the computing system and the functions in accordance with the methods described herein. Therefore, the computing system 400 can be used to implement the methods described above associated with the processing of seismic data from a subsurface. Hardware, firmware, software or a combination thereof may be used to perform the various steps and operations described herein.

Methods and systems in accordance with exemplary embodiments can be hardware embodiments, software embodiments or a combination of hardware and software embodiments. In one embodiment, the methods described herein are implemented as software. Suitable software embodiments include, but are not limited to, firmware, resident software and microcode. In addition, exemplary methods and systems can take the form of a computer program product accessible from a computer-usable or computer-readable medium providing program code for use by or in connection with a computer, logical processing unit or any instruction execution system. In one embodiment, a machine-readable or computer-readable medium contains a machine-executable or computer-executable code that when read by a machine or computer causes the machine or computer to perform a method for method for inversion of multi-vintage seismic data in accordance with exemplary embodiments and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages.

As used herein, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums and include non-transitory computer-readable mediums. Suitable computer-readable mediums include, but are not limited to, a semiconductor or solid state memory, magnetic tape, a removable computer diskette, a random access memory (RAM), a read-only memory (ROM), a rigid magnetic disk and an optical disk. Suitable optical disks include, but are not limited to, a compact disk-read only memory (CD-ROM), a compact disk-read/write (CD-R/W) and DVD.

The disclosed exemplary embodiments provide a computing device, software and method for method for inversion of multi-vintage seismic data. It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software, or firmware tangibly embodied in a computer-readable storage medium for execution by a geophysics dedicated computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for inversion of multi-vintage seismic data, the method comprising:
obtaining seismic data of a subsurface structure for a plurality of vintages;
generating an initial earth model of the subsurface structure for each one of the plurality of vintages;
defining a cost function comprising a data norm term comprising for at least one pair of vintages of seismic data, a difference norm between a difference in obtained seismic data for the at least one pair of vintages and a difference in modeled seismic data for the at least one pair of vintages; and
adjusting the earth models for the at least one pair of vintages to drive the cost function to a minimum and to produce updated earth models for the subsurface structure for the at least one pair of vintages.

2. The method of claim 1, wherein:
one vintage in the at least one pair of vintages comprises a baseline vintage; and
defining the cost function further comprises defining the cost function comprising the data norm term comprising a difference norm between obtained seismic data for the baseline vintage and modeled seismic data for the baseline vintage.

3. The method of claim 1, wherein defining the cost function further comprises defining the cost function comprising the data norm term comprising for each pair of vintages selected from at least three vintages of seismic data a difference norm between the difference in obtained seismic data for a given pair of vintages and the difference in modeled seismic data for the given pair of vintages.

4. The method of claim 3, wherein adjusting the earth models further comprises adjusting the earth models for the at least three vintages to drive the cost function to a minimum and to produce updated earth models for the subsurface structure for the at least three vintages.

5. The method of claim 1, wherein the modeled seismic data for a given vintage comprises a function of the earth model for that given vintage.

6. The method of claim 1, wherein defining the cost function further comprises defining the cost function comprising a model norm term comprising for each pair of vintages selected from at least three vintages of seismic data a difference norm between earth models for a given pair of vintages.

7. The method of claim 6, wherein defining the cost function further comprises defining the cost function comprising the model norm term comprising a Lagrange multiplier for each difference norm between earth models for the given pair of vintages.

8. The method of claim 6, wherein defining the cost function further comprises defining the cost function comprising the model norm term comprising the difference norm between earth models for the given pair of vintages wherein each difference in the difference norm is acted upon by an operator.

9. The method of claim 6, further comprising imposing a closure relationship on all earth models from the at least three vintages in the plurality of vintages, the closure relationship defining consistent differences between all possible combinations of differences between earth models of subsequent vintages.

10. A method for inversion of multi-vintage seismic data, the method comprising:
obtaining seismic data of a subsurface structure for a plurality of vintages;
generating an initial earth model of the subsurface structure for each one of the plurality of vintages;
defining a cost function comprising a model norm term for each pair of vintages selected from at least three vintages of seismic data, each model norm term comprising a difference norm between earth models for a given pair of vintages; and
adjusting the earth models for the at least three vintages to drive the cost function to a minimum and to produce updated earth models for the subsurface structure for the at least three vintages.

11. The method of claim 10, wherein defining the cost function further comprises defining the cost function comprising the model norm term comprising a Lagrange multiplier for each difference norm between earth models for the given pair of vintages.

12. The method of claim 10, wherein defining the cost function further comprises defining the cost function comprising the model norm term comprising the difference norm between earth models for the given pair of vintages wherein each difference in the difference norm is acted upon by an operator.

13. The method of claim 10, further comprising imposing a closure relationship on all earth models from the at least three vintages in the plurality of vintages, the closure relationship defining consistent differences between all possible combinations between earth models of subsequent vintages.

14. The method of claim 10, wherein defining the cost function further comprises defining the cost function comprising a data norm term.

15. The method of claim 14, wherein:
one vintage in the at least three vintages comprises a baseline vintage; and
defining the cost function further comprises defining the cost function comprising the data norm term comprising a difference norm between obtained seismic data for the baseline vintage and modeled seismic data for the baseline vintage.

16. A computing system for inversion of multi-vintage seismic data, the computing system comprising:
a communication module to obtain seismic data of a subsurface structure for a plurality of vintages; and
a processer in communication with the communication module and configured to:
generate an initial earth model of the subsurface structure for each one of the plurality of vintages;
define a cost function comprising a data norm term comprising for at least one pair of vintages of seismic data a difference norm between a difference in obtained seismic for the at least one pair of vintages and a difference in modeled seismic data for the at least one pair of vintages; and
adjust the earth models for the at least one pair of vintages to drive the cost function to a minimum and to produce updated earth models for the subsurface structure for the at least one pair of vintages.

17. The computing system of claim 16, wherein:
one vintage in the at least one pair of vintages comprises a baseline vintage; and
the processor is further configured to define the cost function comprising the data norm term comprising a difference norm between obtained seismic data for the baseline vintage and modeled seismic data for the baseline vintage.

18. The computing system of claim 16, wherein the processor is further configured to:
define the cost function comprising a model norm term comprising for each pair of vintages selected from at least three vintages of seismic data a difference norm between earth models for a given pair of vintages; and
impose a closure relationship on all earth models from the at least three vintages in the plurality of vintages, the closure relationship defining a consistent differences between all possible combinations of differences between earth models of subsequent vintages.

19. The computing system of claim 18, wherein the processor is further configured to define the cost function comprising the model norm term comprising a Lagrange multiplier for each difference norm between earth models for the given pair of vintages.

20. The computing system of claim 18, wherein the processor is further configured to define the cost function comprising the model norm term comprising the difference norm between velocity models for the given pair of vintages wherein each difference in the difference norm is acted upon by an operator.
